(19) United States
(12) Patent Application Publication
(10) Pub. No.: US 2022/0385780 A1
(43) Pub. Date: Dec. 1, 2022

(54) IMAGE FORMING SYSTEM

(71) Applicant: KYOCERA Document Solutions Inc., Osaka (JP)

(72) Inventor: Takayuki OKUMURA, Osaka-shi (JP)

(73) Assignee: KYOCERA Document Solutions Inc., Osaka (JP)

(21) Appl. No.: 17/752,466

(22) Filed: May 24, 2022

(30) Foreign Application Priority Data
May 26, 2021 (JP) 2021-088106

(51) Int. Cl. H04N 1/00; G06F 1/3234; G06F 9/4401

(52) U.S. Cl. CPC H04N 1/00891; H04N 1/00244; H04N 1/00896; G06F 1/3234; G06F 9/442; H04N 2201/33307; H04N 2201/0094

(57) ABSTRACT

An image forming system includes at least one piece of image forming apparatus and a server. The at least one piece of image forming apparatus transmits a sleep notification when entering a sleep mode which is a power saving state, and transmits a wake-up notification when returning from the sleep mode to a non-power saving state. The server monitors the sleep notification and the wake-up notification. When a specific image forming apparatus of the at least one piece of image forming apparatus has been in the sleep mode for at least a certain period of time, the sever issues a power-off command to the specific image forming apparatus, so that the specific image forming apparatus shuts off automatically. Before issuing the power-off command, the server delivers a power-off notice to the user who has used the specific image forming apparatus.

### INCORPORATION BY REFERENCE

The present application claims priority under 35 U.S.C. § 119 to Japanese Patent Application No. 2021-088106, filed on May 26, 2021. The contents of this application are incorporated herein by reference in their entirety.

### BACKGROUND

The present disclosure relates to an image forming system.

Conventional image forming systems include a host computer and at least one piece of image forming apparatus. After transmitting a response request to the host computer, the image forming apparatus shuts off automatically in a case that there is no response received or in a case that it has not received the response content during a certain period.

### SUMMARY

An image forming system according to an aspect of the present disclosure includes at least one piece of image forming apparatus and a server. The at least one piece of image forming apparatus transmits a sleep notification when entering a sleep mode which is a power saving state, and transmits a wake-up notification when returning from the sleep mode to a non-power saving mode. The server monitors the sleep notification and the wake-up notification. In a case that a specific image forming apparatus of the at least one piece of image forming apparatus has been in the sleep mode for at least a certain period of time, the sever issues a power-off command to the specific image forming apparatus, so that the specific image forming apparatus shuts off automatically. Before issuing the power-off command, the server delivers a power-off notice to a user who has used the specific image forming apparatus.

### BRIEF DESCRIPTION OF THE DRAWINGS

FIG. 1 is a block diagram illustrating an example of a configuration of an image forming system according to an embodiment.

FIG. 2 is a schematic view illustrating an example of a structure of an image forming apparatus.

FIG. 3 is a sequence diagram illustrating an example of an operation of the image forming system.

FIG. 4 is a sequence diagram illustrating another example of the operation of the image forming system.

### DETAILED DESCRIPTION

In the present disclosure, we assume a situation that few employees keep working overtime in an office where there are 10 pieces of image forming apparatus, for example. The majority of the 10 pieces of image forming apparatus keep a sleep mode which is a power saving state because of a few print job to be done. The present disclosure achieves compatibility between improved usability and power saving in such case.

The following describes an embodiment of the present disclosure with reference to the accompanying drawings. In the drawings, like elements will be indicated using like reference numerals and descriptions thereof are not repeated.

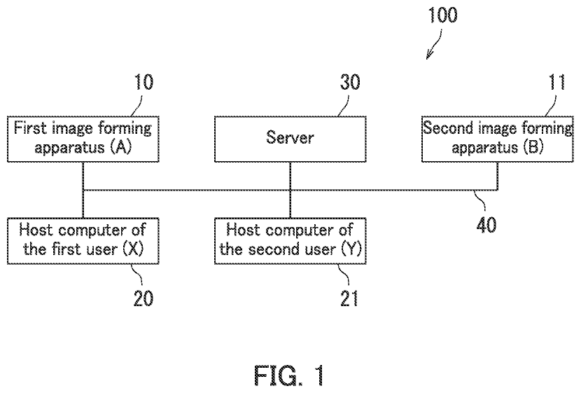

A configuration of an image forming system 100 according to an embodiment will now be described with reference to FIG. 1. FIG. 1 is a block diagram illustrating an example of the configuration of the image forming system 100.

Referring to FIG. 1, the image forming system 100 includes a first image forming apparatus 10 named “A”, a second image forming apparatus 11 named “B”, a host computer 20 of a first user X, a host computer 21 of a second user Y, and a server 30. The first image forming apparatus 10, the second image forming apparatus 11, the host computer 20 of the first user X, the host computer 21 of the second user Y, and server 30 are connected and communicative with each other via a network 40. The network 40 includes a local area network (LAN). The first image forming apparatus 10 and the second image forming apparatus 11 are an example of the “at least one piece of image forming apparatus”.

The first image forming apparatus 10 and the second image forming apparatus 11 each transmit, to the server 30, a sleep notification when entering a sleep mode which is a power saving state, and a wake-up notification when returning from the sleep mode to a non-power saving mode. However, in a case that the first image forming apparatus 10 and the second image forming apparatus 11 each has been set to an overnight operation mode for some reasons such as for transmission or reception of a facsimile, they do not transmit the sleep notification even when entering the sleep mode. The server 30 monitors the sleep notification and the wake-up notification of each of the first image forming apparatus 10 and the second image forming apparatus 11.

In a case that the first image forming apparatus 10 has been in the sleep mode for at least a certain period of time (for example, 2 hours), the server 30 issues a power-off command to the first image forming apparatus 10, so that the first image forming apparatus 10 shuts off automatically. Additionally, before issuing the power-off command, the server 30 delivers a power-off notice by E-mail or the like to users who have used the first image forming apparatus 10. The user who has received the power-off notice may send a power-off rejecting notification to the server 30, in a case that the user plans to use the first image forming apparatus 10. When receiving a power-off rejecting notification as a response to the power-off notice of the first image forming apparatus 10, the server 30 does not issue the power-off command to the first image forming apparatus 10.

In a case that the second image forming apparatus 11 has been in the sleep mode for at least a certain period of time (for example, 2 hours), the server 30 issues a power-off command to the second image forming apparatus 11, so that the second image forming apparatus 11 shuts off automatically. Additionally, before issuing the power-off command, the server 30 delivers a power-off notice by E-mail or the like to users who have used the second image forming apparatus 11. The user who has received the power-off notice may send a power-off rejecting notification to the server 30, in a case the user plans to use the second image forming apparatus 11. When receiving a power-off rejecting notification as a response to the power-off notice of the second image forming apparatus 11, the server 30 does not issue the power-off command to the second image forming apparatus 11.

The power-off notice includes time to be powered off, a piece of information (name or IP address) which specifies the image forming apparatus to be powered off, and a piece of information (name or IP address) which specifies a recommend alternative apparatus from the two pieces of image forming apparatus excluding the one to be powered off. The server 30 preferentially specifies, as the recommend alternative apparatus, an image forming apparatus that is in a non-sleep state. The non-sleep state may be a print state or a ready state.

When the number N of the two pieces of image forming apparatus which have not been shut off of the first image forming apparatus 10 and the second image forming apparatus 11 is not greater than a predetermined number (for example, N=1), the server 30 does not issue the power-off command. This is capable of achieving enhanced user-friendliness.

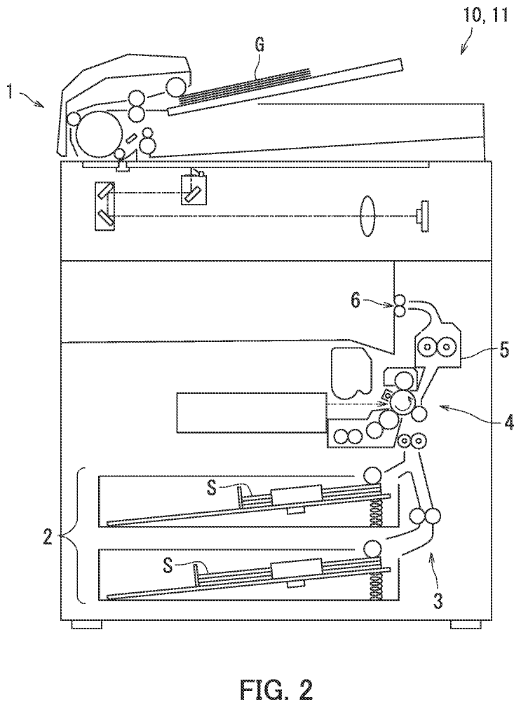

The configuration of the first image forming apparatus 10 will now be described with reference to FIG. 1 and FIG. 2. FIG. 2 is a diagram illustrating an example of the configuration of the first image forming apparatus 10. The second image forming apparatus 11 has the same configuration as the first image forming apparatus 10, and descriptions thereof are not repeated.

As illustrated in FIG. 2, the first image forming apparatus 10 includes a reading section 1, feeding sections 2, conveyance sections 3, an image forming section 4, a fixing section 5, and an ejection section 6.

The reading section 1 reads an image of a document G and generates image data from the read image. The feeding section 2 accommodates a plurality of sheets S, and feeds the sheet S to the conveyance section 3. The sheet S is made from, for example, paper or synthetic resin. The conveyance section 3 includes a plurality of conveyance roller pairs, and transports the sheet S to the image forming section 4.

The image forming section 4 electrophotographically generates a toner image on the sheet S. The image forming section 4 includes a photosensitive drum, a charging device, a light exposure device, a development device, a replenishment device, a transfer device, a cleaning device, and a static elimination device. The toner image indicates the image of the document G, for example. The fixing section 5 applies heat and pressure to the toner image to fix the toner image on the sheet S. The conveyance section 3 transports, to the ejection section 6, the sheet S on which the toner image has been fixed. The ejection section 6 ejects the sheet S out of the first image forming apparatus 10.

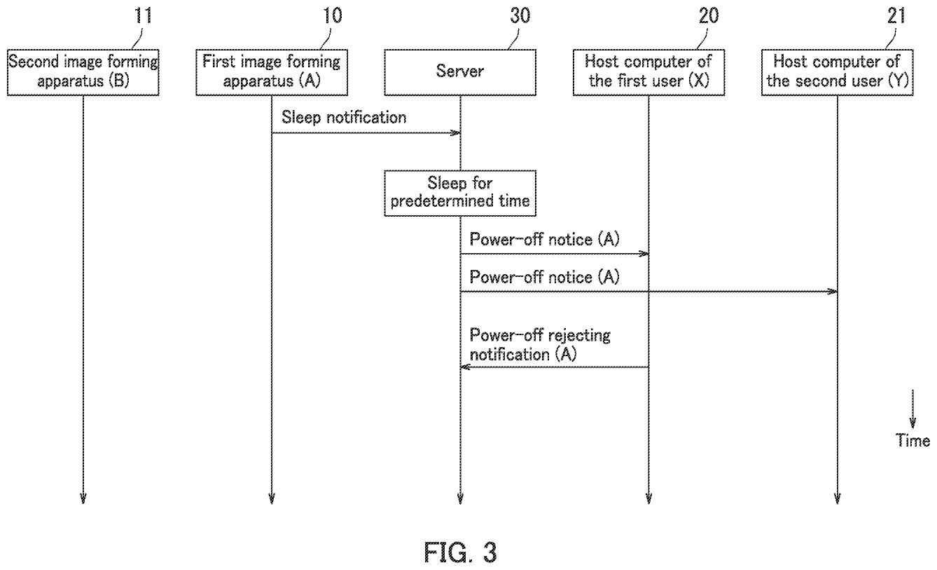

The following describes an operation of the image forming system 100 with reference to FIGS. 1 to 3. FIG. 3 is a sequence diagram illustrating an example of an operation of the image forming system 100 in a case where the first user X refuse to power off.

As illustrated in FIG. 3, when entering the sleep mode, the first image forming apparatus 10 transmits the sleep notification to the server 30. The server 30 monitors the sleep notification and the wake-up notification of each of the first image forming apparatus 10 and the second image forming apparatus 11 to grasp a sleep time of each of the first image forming apparatus 10 and the second image forming apparatus 11. When the sleep time of the first image forming apparatus 10 exceeds a predetermined time (for example, 2 hours), the server 30 delivers a power-off notice to the first user X and the second user Y who have used the first image forming apparatus 10. The server 30 has received a power-off rejecting notification from the first user X during the predetermined time, so it does not issue a power-off command to the first image forming apparatus 10. As such, the first image forming apparatus 10 keeps the sleep mode.

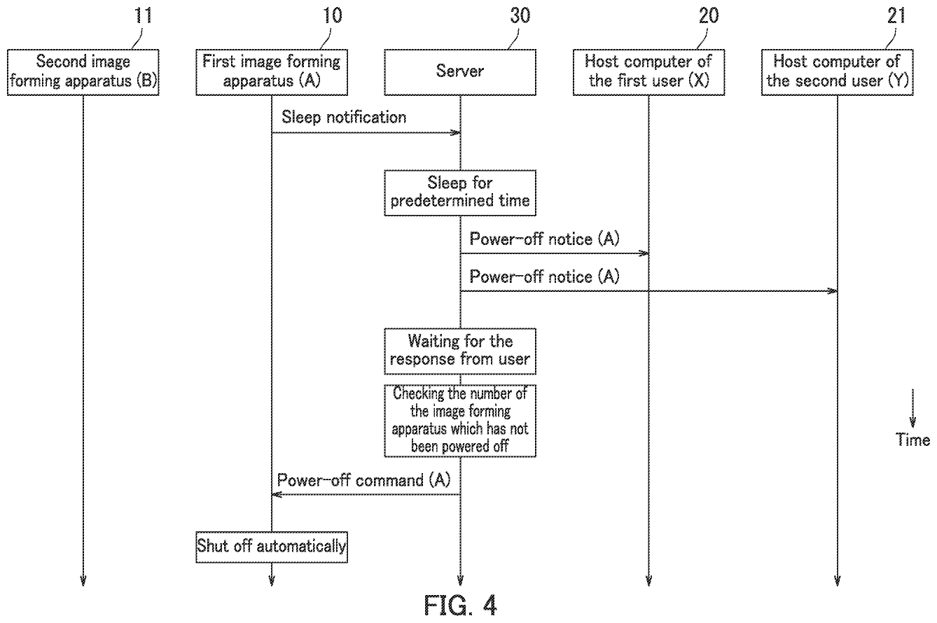

The operation of the image forming system 100 will now be further described with reference to FIGS. 1 to 4. FIG. 4 is a sequence diagram illustrating another example of the operation of the image forming system 100 in a case where the first image forming apparatus 10 is to be powered off.

As illustrated in FIG. 4, when entering the sleep mode, the first image forming apparatus 10 transmits the sleep notification to the server 30. The server 30 monitors the sleep notification and the wake-up notification of each of the first image forming apparatus 10 and the second image forming apparatus 11 to grasp a sleep time of each of the first image forming apparatus 10 and the second image forming apparatus 11. When the sleep time of the first image forming apparatus 10 exceeds a predetermined time (for example, 2 hours), the server 30 delivers a power-off notice to the first user X and the second user Y who have used the first image forming apparatus 10. The server 30 confirms that no power-off rejecting notification has been sent from either of the users during the predetermined time, and also checks that the number N of the two pieces of image forming apparatus which have not been powered off is greater than a predetermined number (for example, N=1). Then the server 30 issues a power-off command to the first image forming apparatus 10, and the first image forming apparatus 10 shuts off automatically.

It is also assumed that both of the first image forming apparatus 10 and the second image forming apparatus 11 have been in the sleep mode for at least a certain period of time (for example, 2 hours). In this case, the server 30 preferentially issues a power-off command to the image forming apparatus having a larger power consumption during sleep between the first image forming apparatus 10 and the second image forming apparatus 11, in viewpoint of power saving.

According to the embodiment, the image forming system 100 compatible with improved usability and power saving is provided.

The server 30 manages an image forming apparatus that is to be powered off and an image forming apparatus that is not to be powered off. The server 30 issues the power-off command to at least one of the plurality pieces of the image forming apparatus via the network 40 to enable the at least one of the plurality pieces of the image forming apparatus to shut oft automatically and keep the remaining N pieces of the image forming apparatus in the sleep mode. This makes it possible to achieve compatibility between improved usability and power saving.

Additionally, before the part of the plurality pieces of the image forming apparatus shut off automatically, the server 30 delivers the power-off notice to the user who has used the image forming apparatus in advance. The server 30 does not issue the power-off command when receiving the power-off rejecting notification from the user. Thus, the server 30 shuts off the image forming apparatus in response to user's intentions. This makes it possible to achieve compatibility between improved usability and power saving.

An embodiment of the present disclosure has been described above with reference to the accompanying drawings. However, the present disclosure is not limited to the above embodiment and can be implemented in various manners within a scope not departing from the gist thereof. Also, a plurality of elements of configuration disclosed in the foregoing embodiments can be combined as appropriate to form various disclosures. For example, some of the elements of configuration disclosed in the embodiments may be omitted. The drawings mainly illustrate various constituent elements schematically for ease of understanding. Aspects such as number of the constituent elements illustrated in the drawings may differ in practice for convenience of drawing preparation. Furthermore, the constituent elements illustrated in the above embodiment are one example and not particular limitations, and can be altered in various ways to the extent without substantially deviating from the effects of the present disclosure.

The first image forming apparatus 10 and the second image forming apparatus 11 are electro-photographic type in the embodiment, for example. However, the present disclosure is not limited to this. At least one of the first image forming apparatus 10 and the second image forming apparatus 11 may be an inkjet type.

The image forming system 100 has two pieces of image forming apparatus in the embodiment. However, the present disclosure is not limited to this. The image forming apparatus may be one or three, or more.

What is claimed is:

1. An image forming system, comprising:
at least one piece of image forming apparatus configured to transmit a sleep notification when entering a sleep mode which is a power saving state, and transmit a wake-up notification when returning from the sleep mode to a non-power saving mode, and
a server configured to monitor the sleep notification and the wake-up notification, wherein
in a case that a specific image forming apparatus of the at least one piece of image forming apparatus has been in the sleep mode for at least a certain period of time, the sever issues a power-off command to the specific image forming apparatus, so that the specific image forming apparatus shuts off automatically,
before issuing the power-off command, the server delivers a power-off notice to a user who has used the specific image forming apparatus.

2. The image forming system according to claim 1, wherein,
the at least one piece of image forming apparatus includes a plurality pieces of image forming apparatus,
the power-off notice includes time to be powered off, a piece of information which specifies the specific image forming apparatus, and a piece of information which specifies a recommend alternative apparatus within the plurality pieces of image forming apparatus excluding the specific image forming apparatus.

3. The image forming system according to claim 2, wherein,
the server preferentially specifies, as the recommend alternative apparatus, an image forming apparatus that is in a non-sleep state, the non-sleep state including a print state and a ready state.

4. The image forming system according to claim 2, wherein,
in a case that a plurality pieces of specific image forming apparatus of the plurality pieces of image forming apparatus has been in the sleep mode for at least the certain period of time, the server preferentially issues a power-off command to a specific image forming apparatus which has a largest power consumption during sleep among the plurality pieces of specific image forming apparatus.

5. The image forming system according to claim 1, wherein,
in a case that the at least one piece of image forming apparatus has been set to an overnight operation mode, the at least one piece of image forming apparatus does not transmit the sleep notification even when entering the sleep mode.

6. The image forming system according to claim 1, wherein,
the server does not issue the power-off command in a case that the server receives a power-off rejecting notification as a response to the power-off notice.

7. The image forming system according to claim 1, wherein,
the server does not issue the power-off command in a case that a number of the image forming apparatus which has not been shut off of the at least one piece of image forming apparatus is not greater than a predetermined number.
